(19) United States
(12) Patent Application Publication
(10) Pub. No.: US 2023/0153078 A1
(43) Pub. Date: May 18, 2023

(54) BRANCH DECISION ELEMENTS

(71) Applicant: salesforce.com, inc., San Francisco, CA (US)

(72) Inventors: Kiran Hariharan Nair, San Ramon, CA (US); Nhi Nguyen, Antony (FR); Samuel William Bailey, Cardiff (GB)

(21) Appl. No.: 17/455,145

(22) Filed: Nov. 16, 2021

(51) Int. Cl. G06F 8/34; G06F 8/71; G06F 8/33

(52) U.S. Cl. CPC G06F 8/34; G06F 8/71; G06F 8/33

(57) ABSTRACT

Techniques are disclosed relating to branch decision elements. A computer system may access process flow information specifying a process flow defining an ordering of elements that include a branch selector element that is connected to branches that flow to a branch return element. The computer system may execute the process flow, including traversing the elements and accessing state information that identifies which of the branches have been evaluated for traversal. Upon reaching the branch selector element, the computer system may determine, based on the state information, whether the branches include a branch that has not been evaluated. In response to determining a branch has not been evaluated, the computer system may determine whether to traverse that branch. Upon reaching the branch return element, the computer system may determine whether to return to the branch selector element based on whether a particular number of the branches have been evaluated.

### BACKGROUND

### Technical Field

This disclosure relates generally to computer systems and, more specifically, to various mechanisms for implementing branch decision elements in flow processes.

### Description of the Related Art

Software as a service (SaaS) describes a software distribution model in which providers maintain applications in a centrally-hosted fashion and make them available to end users over the internet as services. Such services can include customer relationship management services, web hosting services, storage services, email services, and communication-services. In some cases, a service allows users to develop, run, and manage applications using tools that are provided by the service. One type of application that may be developed by a user is a process flow that implements particular logic defined by the user. For example, a user may create a process flow that accesses records from a database, performs a set of computations on the data of those records, and then returns a result to the user.

### BRIEF DESCRIPTION OF THE DRAWINGS

FIG. 1 is a block diagram illustrating example elements of a system that enables process flows to be created that include branch selector elements and branch return elements, according to some embodiments.

FIG. 2 is a block diagram illustrating example elements of a graphical user interface for creating process flows, according to some embodiments.

FIG. 3 is a block diagram illustrating example elements of a process flow that includes branch selector elements and branch return elements, according to some embodiments.

FIG. 4A-B are block diagrams illustrating example elements of element interfaces for a branch selector element and a branch return element, according to some embodiments.

FIG. 5 is a flow diagram illustrating example method that relates to executing a process flow that includes a branch selector element and a branch return element, according to some embodiments.

FIG. 6 is a block diagram illustrating elements of a multi-tenant system, according to some embodiments.

FIG. 7 is a block diagram illustrating elements of a computer system for implementing various systems described in the present disclosure, according to some embodiments.

### DETAILED DESCRIPTION

A service that allows users to create applications often provides tools that enable those users to create the applications without requiring an extensive knowledge of programming. An example tool is a graphical user interface (GUI) that provides a canvas on which users can drag and drop elements that define the logic of an application—a user can thus build code-like logic without having to write code. In some instances, a user desires to implement logic that decides between execution paths of the application and thus adds a decision element that includes logic for selecting one of those paths. In conventional approaches, the decision element can evaluate only two paths, one of which is selected for traversal. But it may be desirable to evaluate many paths and to select multiple of them for traversal at a certain stage in an application's execution. To achieve this end under conventional approaches, many decision elements have to be added to the process flow that defines the application so that the many paths can be evaluated. If there are too many decision elements, then the process flow presented by the GUI can become quite convoluted. As a result, a user may have difficulty understanding the process flow. The present disclosure addresses, among other things, the problem of how to evaluate and select multiple paths for traversal from the same originating element.

In various embodiments described below, a system provides a branch selector element and a branch return element that can be used in building an application, such as a process flow. A user may be presented with a GUI that allows for the user to build a process flow by dragging and dropping elements onto a canvas that graphically presents the process flow. The user may add a branch selector element and a branch return element to the process flow and connect the two elements together via multiple branches/paths that flow from the branch selector element towards the branch return element. In some embodiments, the GUI does not depict a graphical loopback connection from the branch return element to the branch selector element. The GUI may rather present a set of configurable options for the branch return element, one of which is an option for specifying the branch selector element as the return point. After the process flow has been built by the user, the process flow may be compiled into a form that can be processed by the system.

When executing the process flow, the system traverses the elements of the process flow according to an ordering of those elements. Upon reaching a branch selector element, in various embodiments, the system accesses state information that identifies which of the branches that are connected to that branch selector element have been evaluated for traversal. Based on that state information, the system may determine if there is a branch that has not been evaluated. In response to identifying a branch, the system may then traverse that branch if a particular set of criteria have been met. Upon reaching a branch return element, in various embodiments, the system determines whether to return to the branch selector element based on whether a certain number of the branches (e.g., all except a default branch) has been evaluated. The system may further update the state information to indicate that the traversed branch has been evaluated.

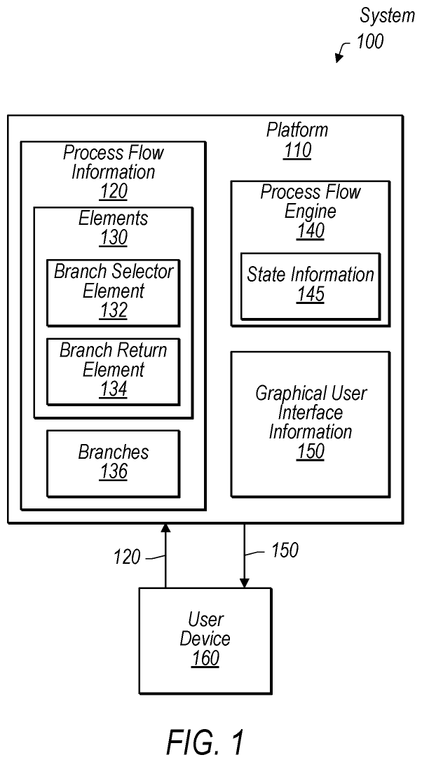

These techniques may be advantageous over conventional approaches as the techniques allow for multiple branches to be sequentially (or, in some cases, concurrently) evaluated and traversed from the same originating element in a process flow. Consequently, multiple decision elements do not have to be added to a process flow (as discussed earlier), resulting in a process flow that may not be convoluted or difficult to understand when presented to a user via a GUI. Also, by not depicting, in the GUI, a loopback connection between the branch selector element and the branch return element, the presentation of the process flow in the GUI might be further simplified. The branch return element may further enable data resulting from traversing various branches to be merged automatically. An exemplary application of these techniques will now be discussed, starting with reference to FIG. 1.

Turning now to FIG. 1, a block diagram of a system 100 is shown. System 100 includes a set of components that may be implemented via hardware or a combination of hardware and software. In the illustrated embodiment, system 100 includes a platform 110 that is coupled to a user device 160 (e.g., via the Internet). As further shown, platform 110 includes process flow information 120, a process flow engine 140 that includes state information 145, and graphical user interface (GUI) information 150. As shown, process flow information 120 includes a set of elements 130, such as a branch selector element 132 and a branch return element 134, and branches 136. In some embodiments, system 100 is implemented differently than shown. For example, process flow information 120 and/or GUI information 150 may be stored at a location that is external to platform 110.

Platform 110, in various embodiments, implements a platform service (e.g., a customer relationship management (CRM) platform service) that allows users of that service to develop, run, and manage applications. Platform 110 may be a multi-tenant system that provides various functionality to users/tenants that are hosted by the multi-tenant system. Accordingly, platform 110 may execute software routines from various, different users (e.g., providers and tenants of platform 110) as well as provide code, web pages, and other data to users, databases, and other entities of platform 110. In various embodiments, platform 110 is implemented using a cloud infrastructure that is provided by a cloud provider. Process flow engine 140 may thus execute on and use the available cloud resources of the cloud infrastructure (e.g., computing resources, storage resources, network resources, etc.) to facilitate its operation. For example, process flow engine 140 may execute in a virtual environment hosted on server-based hardware included in a datacenter of the provider. But in some embodiments, platform 110 is implemented utilizing local or private infrastructure as opposed to a public cloud.

Process flow information 120, in various embodiments, is information that specifies a process flow defining an ordering of elements 132 and branches 136 connecting those elements 132 to one another. Process flow information 120 may be derived from user input provided to a GUI that is rendered on user device 160. Process flow information 120 may include a portion comprising an executable form of the process flow and a portion that can be interpreted by a GUI engine to present a graphical representation of the process flow. In various embodiments, process flow information 120 is sent to process flow engine 140 to execute the corresponding process flow in response to a request or a trigger event. Process flow information 120 may also be provided to user device 160 when a user desires to view and/or modify the process flow. In some embodiments, the above-mentioned portions of process flow information 120 are stored separately and/or can be accessed separately (e.g., the executable form of a process flow might not be sent to user device 160).

As mentioned, a process flow can include elements 130 and branches 136. An element 130, in various embodiments, corresponds to a stage within the process flow and may define a set of actions to be performed as a part of processing that element 130. In some instances, one or more of the actions of an element 130 may be performed only if certain criteria are met (e.g., if manager approval is received). Once an element 130 has been processed, the corresponding process flow may be traversed to reach another element 130 via a branch 136 that connects the two elements 130. In various cases, two elements 130 (e.g., a branch selector element 132 and a branch return element 134) are connected via a branch 136 that itself includes other elements 130. Thus, traversing that branch 136 can include executing the elements 130 included within that branch 136. For example, traversing from a branch selector element 132 to a branch return element 134 via a connecting branch 136 might include processing a load element to load a set of records and a filter element 130 to filter those records. In some embodiments, a branch 136 is associated with a set of criteria that is to be met in order to traverse that branch 136. For example, if a user that is being evaluated is not an employee, then a branch that includes actions to be performed in relation to an employee may not be traversed.

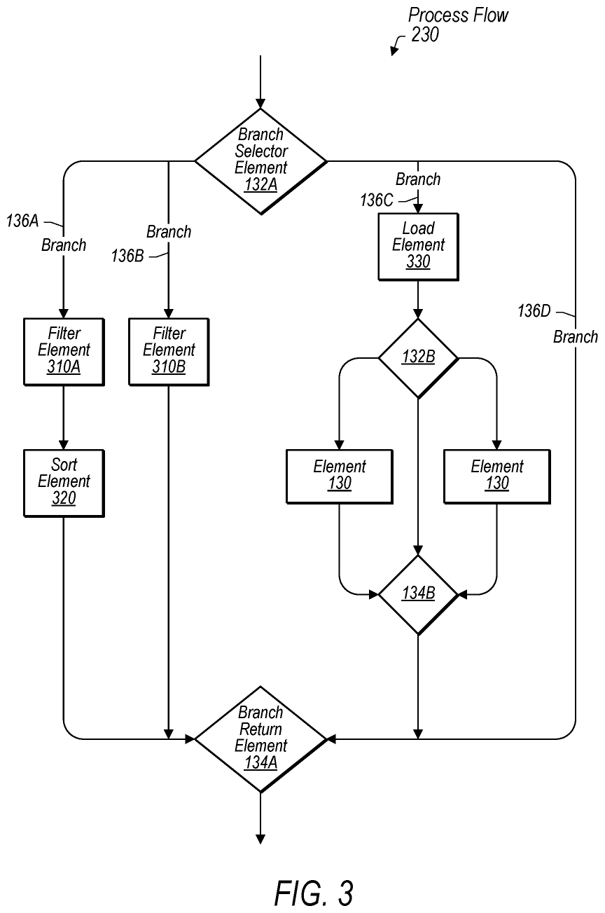

A branch selector element 132, in various embodiments, is a particular type of element 130 capable of evaluating multiple branches 136 and causing one or more of the branches 136 to be traversed. A branch selector element 132 may be coupled to a branch return element 134 via the branches 136 that flow from that branch selector element 132. A branch return element 134, in various embodiments, is a particular type of element 130 capable of causing the process flow execution to return to a branch selector element 132, enabling the branch selector element 132 to evaluate and potentially traverse another branch 136. Thus, a branch return element 134 may include logic for deciding whether execution flow should be returned to its coupled branch selector element 132. For example, if all but a default branch 136 connected to a branch selector element 132 have been evaluated, then the branch return element 134 may not return execution flow to that branch selector element 132. Instead, a branch 136 that flows out from the branch return element 134 might be traversed. An example process flow that includes branch selector elements 132 and branch return elements 134 is discussed in greater detail with respect to FIG. 3.

Process flow engine 140, in various embodiments, facilitates the execution of a process flow that is defined by process flow information 120. As mentioned, process flow information 120 may include an executable form of the process flow that is provided to process flow engine 140. Consequently, process flow engine 140 may execute that executable form to perform the process flow. As a part of performing the process flow, in various embodiments, process flow engine 140 accesses and maintains state information 145 that identifies various states that are associated with that process flow. For example, state information 145 may identify whether a branch 136 has been evaluated. Accordingly, in response to evaluating a branch 136, in various embodiments, process flow engine 140 updates, independent of whether that branch 136 is traversed, state information 145 to indicate that it has been evaluated. When processing a branch return element 134, process flow engine 140 may use state information 145 in order to determine whether there exists a branch 136 that has not been evaluated by a corresponding branch selector element 132 and thus if process flow engine 140 should process the branch selector element 132 again. Process flow engine 140 may further use state information 145 to determine which branch 136 to evaluate when processing a branch selector element 132.

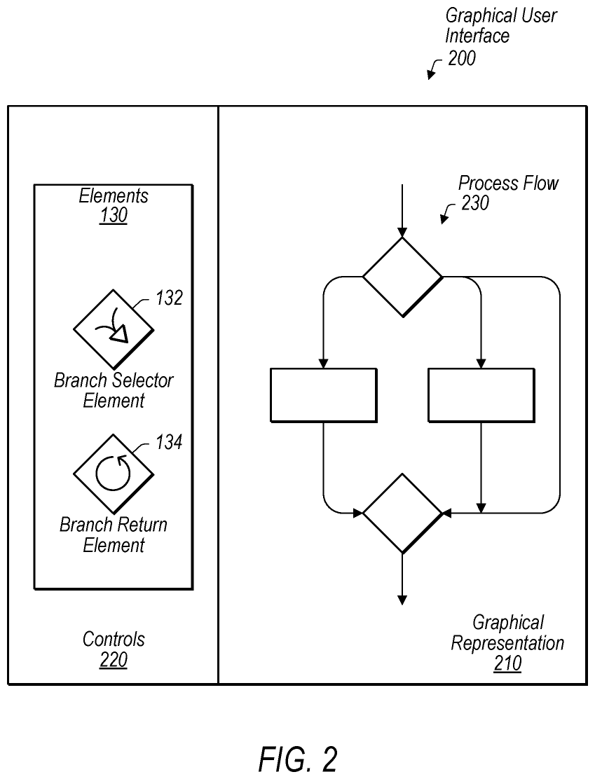

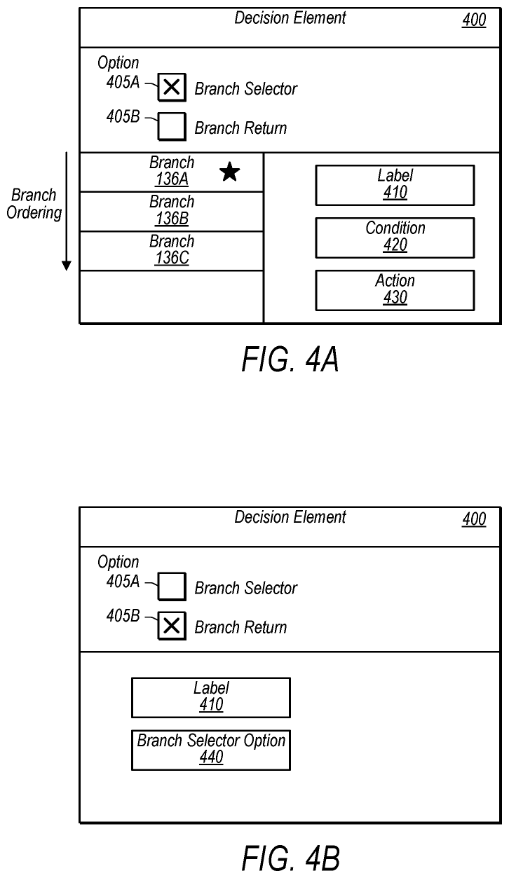

GUI information 150, in various embodiments, includes information that is executable to render a GUI that can be used to build process flows. As illustrated, GUI information 150 is provided to user device 160, which may render that GUI to a requesting user. As discussed in more detail with respect to FIG. 2, the GUI presents selectable elements 130 that can be dragged and dropped onto a graphical representation of a process flow to build that process flow. Also, as discussed with respect to FIGS. 4A-B, the GUI may present additional interfaces that enable a user to configure elements 130 that have been added to a process flow. For example, the GUI may present an interface that enables a user to specify a particular branch selector element 132 as the return point of a branch return element 134. In various embodiments, GUI information 150 includes information that is executable to generate process flow information 120 according to a process flow being built by a user using the GUI. Consequently, a user may select a save and/or compile option to cause user device 160 to create process flow information 120, which may include the executable form of the process flow. User device 160 can then provide process flow information 120 to platform 110 as shown.

Turning now to FIG. 2, a block diagram of an example graphical user interface (GUI) 200 for creating process flows 230 is shown. In the illustrated embodiment, GUI 200 includes a graphical representation 210 of a process flow 230 and controls 220. As shown, controls 220 comprises elements 130, including a branch selector element 132 and a branch return element 134. In some embodiments, GUI 200 is implemented differently than shown. As an example, GUI 200 may include a legend for interpreting the meaning of different symbols shown within graphical representation 210.

Graphical representation 210, in various embodiments, shows a visual view of process flow 230 that may enable a user to more easily interpret and understand process flow 230. In some embodiments, certain visual aspects may be auto generated as opposed to being defined by a user. As an example, a user may identify connections between elements 130 but GUI 200 may render, in graphical representation 210, the branches 136 between the elements 130 based on layout policies. Those layout policies may attempt to simply the visual view of process flow 230 and standardize the visual view across different process flows 230. For example, graphical representation 210 may not depict a branch 136 (or, a loopback connection) that flows from a branch return element 134 to a branch selector element 132. As another example, branches 136 that flow into an element 130 may be depicted as connecting to the upper portion of the element 130 while branches 136 that flow from the element may be depicted as connecting to the lower portion of that element 130. As a result of the layout policies, the visual view of process flow 230 may be less convoluted.

Controls 220, in various embodiments, include components that enable a user to build and configure process flow 230. As shown for example, controls 220 include elements 130 that can be dragged and dropped by a user onto graphical representation 210. As another example, controls 220 may include menus that enable a user to change the view of process flow 230 that is presented in graphical representation 210. In some embodiments, controls 220 enable a user to cause an element interface to be presented for an element 130 so that the user can configure that element 130 (e.g., by providing user input into fields defined for the element 130). While not shown, controls 220 may include a save option for saving process flow 230 and a compile option for compiling process flow 230 into an executable.

Turning now to FIG. 3, a block diagram of elements of an example process flow 230 is shown. Within the illustrated embodiment, process flow 230 includes a branch selector element 132A that is connected to branches 136A-D that flow towards a branch return element 134A. As further shown, branch 136A includes a filter element 310A that flows to a sort element 320, branch 136B includes a filter element 310B, and branch 136C includes a load element 330 that flows to a nested group of elements 130 that include another branch selector element 132B and another branch return element 134B. Also as depicted, branch 136D does not include elements 130. In some cases, process flow 230 is implemented differently than shown. As an example, process flow 230 might not include the nested group of elements 130 that are a part of branch 136C.

As mentioned, process flow engine 140 may begin executing process flow 230 defined in process flow information 120 in response to a trigger (e.g., a user request, the occurrence of a particular event, a time interval passing, etc.). As part of executing process flow 230, process flow engine 140 traverses elements 130 of process flow 230 according to an ordering. During that execution, process flow engine 140 may arrive at branch selector element 132A and then process that element. When processing branch selector element 132A, process flow engine 140 evaluates branches 136A-C sequentially (or concurrently in some embodiments). Accordingly, process flow engine 140 may initially evaluate branch 136A. As mentioned, a branch 136 may be associated with a set of criteria that have to be met before that branch 136 is traversed. Thus, if branch 136A is associated with criteria and those criteria are met, then process flow engine 140 traverses branch 136A. For example, process flow 230 may be executed in association with a particular user and branch 136A may involve actions that are preformed in relation to an elite member. Thus, if the particular user is an elite member, then branch 136A is traversed. After evaluating whether branch 136A should be taken, in various embodiments, process flow engine 140 updates state information 145 to indicate that branch 136A has been evaluated. If branch 136A is not associated with criteria, then process flow engine 140 may automatically traverse branch 136A.

As shown, traversing branch 136A involves processing a filter element 310A and a sort element 320. A filter element 310, in various embodiments, is a type of element 130 in which data is filter based on a set of criteria. As an example, a set of discounts may be filtered based on geographical information about a user that is associated with the execution of process flow 230. A sort element 320, in various embodiments, is another type of element 130 in which data is sorted based on a set of criteria. For example, the filtered discounts may be sorted according to their value. After processing those two elements, process flow engine 140 arrives at branch return element 134A. When processing branch return element 134A, process flow engine 140 may store the results of traversing branch 136A (e.g., as part of state information 145) and then determine whether to return to branch selector element 132A. Based on state information 145, process flow engine 140 may determine that branches 136B and 136C still need to be evaluated and thus may return to branch selector element 132A.

Upon returning to branch selector element 132A, process flow engine 140 may evaluate branch 136B. In some cases, branch 136B is associated with a set of criteria that is not met. In response to determining that the set of criteria is not met, process flow engine 140 may evaluate branch 136C without traversing branch 136B; otherwise, process flow engine 140 may traverse branch 136B and may merge its results with the results of branch 136A when processing branch return element 134A. After evaluating branch 136B, process flow engine 140 then evaluates branch 136C. If process flow engine 140 determines to not traverse branch 136C, then process flow engine 140 may automatically traverse default branch 136D as there are no other branches 136 to evaluate in the illustrated embodiment. A default branch 136, in various embodiments, does not include any actions to be performed as part of traversing that branch. Upon reaching a branch return element 134 from a default branch 136, in various embodiments, process flow engine 140 determines to not return to the corresponding branch selector element 132 without considering state information 145.

As shown, traversing branch 136C involves processing a load element 330 and another group of elements 130, including a branch selector element 132B and a branch return element 134B that are nested within branch selector element 132A and branch return element 134A. A load element 330, in various embodiments, is a type of element 130 that involves loading data from a data source, such as a database of platform 110. Data loaded by load element 330 may be passed into the subsequent group of elements 130 within branch 136C. After evaluating the branches 136 coupled to branch selector element 132B, process flow engine 140 traverses from branch return element 134B to branch return element 134A. Process flow engine 140 may then merge the results of branch 136C with the results from the other branches 136. In response to determining that there are no other branches to evaluate, process flow engine 140 may proceed to another element 130 of process flow 230 from branch return element 134A.

Turning now to FIG. 4A, a block diagram of an example element interface for a decision element 400 that is selected to be a branch selector element 132 is shown. Within the illustrated embodiment, the element interface for decision element 400 includes a section having options 405A-B for defining decision element 400 as a branch selector element 132 or a branch return element 134, respectively. In particular, in various embodiments, branch selector elements 132 and branch return elements 134 inherit properties from a parent branch decision element. Thus, when wishing to insert one of those two elements, a user may select and insert decision element 400 into a process flow 230. Accordingly, in some embodiments, GUI 200 provides decision element 400 under controls 220 instead of a branch selector element 132 and a branch return element 134. After inserting decision element 400, the user may interact with decision element 400 to cause GUI 200 to present an element interface for configuring it. The user may then select option 405A or 405B to cause decision element 400 to become a branch selector element 132 or a branch return element 134, respectively. But in various embodiments, branch selector elements 132 and branch return elements 134 do not inherit properties from decision element 400 and thus two separate interfaces without options 405A-B may be presented for those two types of elements.

As depicted in FIG. 4A, option 405A has been selected and thus decision element 400 becomes a branch selector element 132. As a result, a portion of the interface of decision element 400 enables a user to define branches 136 coupled to the branch selector element 132 and, for each branch 136, a label 410, a set of conditions 420, and a set of actions 430. As shown, branches 136A-C have been defined for the illustrated branch selector element 132, with branch 136A being the first branch 136 according to a defined branch ordering. In various embodiments, processing a branch selector element 132 involves processing its branches 136 in the order specified by a user via GUI 200. A label 410, in various embodiments, is a value applied to an element 130 that can be used to identify that element 130 to other components of a process flow 230. A condition 420, in various embodiments, is a condition that has to be met before a corresponding branch 136 can be traversed. An action 430, in various embodiments, is an operation to be performed as part of traversing a branch 136. An action 430 may specify an element 130, such as a filter element 310.

Turning now to FIG. 4B, a block diagram of an example element interface for a decision element 400 that is selected to be a branch return element 134 is shown. Accordingly, as shown in FIG. 4B, option 405B has been selected and therefore decision element 400 becomes a branch return element 134. As a result, a portion of the interface of decision element 400 changes to permit a user to specify a label 410 for branch return element 134 and a branch selector option 440 to identify a branch selector element 132. A user may identify a branch selector element 132 by specifying the value of the label 410 associated with that branch selector element 132.

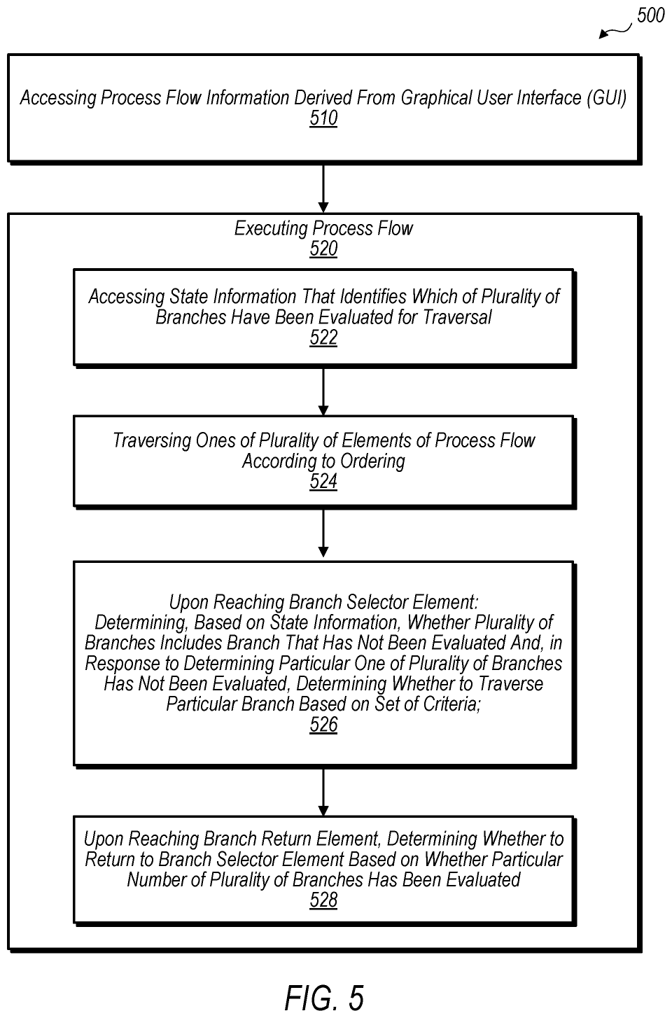

Turning now to FIG. 5, a flow diagram of a method 500 is shown. Method 500 is one embodiment of a method performed by a computer system (e.g., platform 110) to execute a process flow (e.g., a process flow 230) that includes a branch selector element (e.g., a branch selector element 132) and a branch return element (e.g., a branch return element 134). Method 500 may be performed by executing program instructions stored on a non-transitory computer-readable medium. Method 500 may be performed in response to the occurrence of an event, such as a user issuing a request to the computer system to execute the process flow. In some embodiments, method 500 includes more or less steps than shown. For example, method 500 may include a step in which the process flow is stored at the computer system.

Method 500 begins in step 510 with the computer system accessing process flow information (e.g., process flow information 120) derived from a graphical user interface (GUI) (e.g., GUI 200). In various embodiments, the computer system sends GUI information (e.g., GUI information 150) that is executable by another computer system (e.g., user device 160) to display the GUI. The GUI includes a set of elements (e.g., elements 130) selectable by a user to build the process flow and a graphical representation (e.g., graphical representation 210) that depicts the process flow. The computer system may receive the process flow information from the other computer system.

In some cases, the process flow information specifies the process flow, which defines an ordering of a plurality of elements of the process flow. The plurality of elements includes a branch selector element that is connected to a plurality of branches (e.g., branches 136) that flow to a branch return element. A given branch of the plurality of branches may include a set of actions (e.g., actions of filter element 310A, sort element 320, etc.) to be performed as part of traversing the given branch. In some embodiments, the branch return and branch selector elements inherit a set of features from a parent branch element (e.g., decision element 400). The GUI may present an element interface for the parent branch element that includes a set of options (e.g., options 405A and 405B) for defining the parent branch element as a branch return element or a branch selector element. The plurality of branches may include a default branch (e.g., branch 136D) that does not include any actions to be performed as part of traversing the default branch. In some cases, the process flow does not include a default branch and thus the branch return element may execute the next element in the process flow after all of the branches have been evaluated.

In step 520, the computer system executes the process flow. As a part of executing the process flow, in step 522, the computer system accesses state information (e.g., state information 145) that identifies which of the plurality of branches have been evaluated for traversal. In step 524, the computer system traverses ones of the plurality of elements of the process flow according to the ordering. In step 526, upon reaching the branch selector element: the computer system determines, based on the state information, whether the plurality of branches includes a branch that has not been evaluated and in response to determining a particular one of the plurality of branches has not been evaluated, determines whether to traverse the particular branch based on a set of criteria. The computer system may evaluate the plurality of branches in an order specified by a user via the GUI. In response to determining that the set of criteria associated with the particular branch are not satisfied, the computer system may evaluate another branch of the plurality of branches without traversing the particular branch. The set of criteria for the particular branch may include a criterion that a user associated with the process flow be part of a particular group of users. In some cases, the particular branch includes another branch selector element and another branch return element. In response to evaluating the particular branch, the computer system may update, independent of whether the particular branch is traversed, the state information to indicate that the particular branch has been evaluated. In step 528, upon reaching the branch return element, the computer system determines whether to return to the branch selector element based on whether a particular number (e.g., all but a default branch) of the plurality of branches has been evaluated. In some cases, the computer system determines to not return to the branch selector element based on the default branch being traversed. The graphical representation may not depict a graphical loopback connection from the branch return element to the branch selector element.

### Exemplary Multi-Tenant Database System

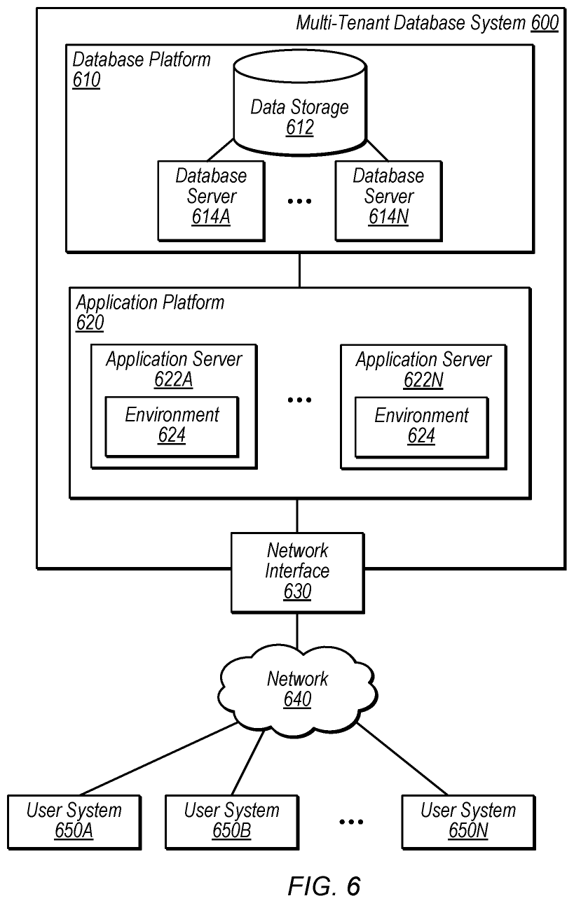

Turning now to FIG. 6, an exemplary multi-tenant database system (MTS) 600 in which various techniques of the present disclosure can be implemented is shown—e.g., system 100 may be MTS 600. In FIG. 6, MTS 600 includes a database platform 610, an application platform 620, and a network interface 630 connected to a network 640. Also as shown, database platform 610 includes a data storage 612 and a set of database servers 614A-N that interact with data storage 612, and application platform 620 includes a set of application servers 622A-N having respective environments 624. In the illustrated embodiment, MTS 600 is connected to various user systems 650A-N through network 640. The disclosed multi-tenant system is included for illustrative purposes and is not intended to limit the scope of the present disclosure. In other embodiments, techniques of this disclosure are implemented in non-multi-tenant environments such as client/server environments, cloud computing environments, clustered computers, etc.

MTS 600, in various embodiments, is a set of computer systems that together provide various services to users (alternatively referred to as “tenants”) that interact with MTS 600. In some embodiments, MTS 600 implements a customer relationship management (CRM) system that provides mechanism for tenants (e.g., companies, government bodies, etc.) to manage their relationships and interactions with customers and potential customers. For example, MTS 600 might enable tenants to store customer contact information (e.g., a customer's website, email address, telephone number, and social media), identify opportunities, record service issues, and manage campaigns. Moreover, MTS 600 may enable those tenants to identify how customers have been communicated with, what the customers have bought, when the customers last purchased items, and what the customers paid. To provide the services of a CRM system and/or other services, as shown, MTS 600 includes a database platform 610 and an application platform 620.

Database platform 610, in various embodiments, is a combination of hardware elements and software routines that implement database services for storing and managing data of MTS 600, including tenant data. As shown, database platform 610 includes data storage 612. Data storage 612, in various embodiments, includes a set of storage devices (e.g., solid state drives, hard disk drives, etc.) that are connected together on a network (e.g., a storage attached network (SAN)) and configured to redundantly store data to prevent data loss. In various embodiments, data storage 612 is used to implement a database comprising a collection of information that is organized in a way that allows for access, storage, and manipulation of the information. Data storage 612 may implement a single database, a distributed database, a collection of distributed databases, a database with redundant online or offline backups or other redundancies, etc. As part of implementing the database, data storage 612 may store files that include one or more database records having respective data payloads (e.g., values for fields of a database table) and metadata (e.g., a key value, timestamp, table identifier of the table associated with the record, tenant identifier of the tenant associated with the record, etc.).

In various embodiments, a database record may correspond to a row of a table. A table generally contains one or more data categories that are logically arranged as columns or fields in a viewable schema. Accordingly, each record of a table may contain an instance of data for each category defined by the fields. For example, a database may include a table that describes a customer with fields for basic contact information such as name, address, phone number, fax number, etc. A record therefore for that table may include a value for each of the fields (e.g., a name for the name field) in the table. Another table might describe a purchase order, including fields for information such as customer, product, sale price, date, etc. In various embodiments, standard entity tables are provided for use by all tenants, such as tables for account, contact, lead and opportunity data, each containing pre-defined fields. MTS 600 may store, in the same table, database records for one or more tenants—that is, tenants may share a table. Accordingly, database records, in various embodiments, include a tenant identifier that indicates the owner of a database record. As a result, the data of one tenant is kept secure and separate from that of other tenants so that that one tenant does not have access to another tenant's data, unless such data is expressly shared.

In some embodiments, the data stored at data storage 612 is organized as part of a log-structured merge-tree (LSM tree). An LSM tree normally includes two high-level components: an in-memory buffer and a persistent storage. In operation, a database server 614 may initially write database records into a local in-memory buffer before later flushing those records to the persistent storage (e.g., data storage 612). As part of flushing database records, the database server 614 may write the database records into new files that are included in a “top” level of the LSM tree. Over time, the database records may be rewritten by database servers 614 into new files included in lower levels as the database records are moved down the levels of the LSM tree. In various implementations, as database records age and are moved down the LSM tree, they are moved to slower and slower storage devices (e.g., from a solid state drive to a hard disk drive) of data storage 612.

When a database server 614 wishes to access a database record for a particular key, the database server 614 may traverse the different levels of the LSM tree for files that potentially include a database record for that particular key. If the database server 614 determines that a file may include a relevant database record, the database server 614 may fetch the file from data storage 612 into a memory of the database server 614. The database server 614 may then check the fetched file for a database record having the particular key. In various embodiments, database records are immutable once written to data storage 612. Accordingly, if the database server 614 wishes to modify the value of a row of a table (which may be identified from the accessed database record), the database server 614 writes out a new database record to the top level of the LSM tree. Over time, that database record is merged down the levels of the LSM tree. Accordingly, the LSM tree may store various database records for a database key where the older database records for that key are located in lower levels of the LSM tree then newer database records.

Database servers 614, in various embodiments, are hardware elements, software routines, or a combination thereof capable of providing database services, such as data storage, data retrieval, and/or data manipulation. Such database services may be provided by database servers 614 to components (e.g., application servers 622) within MTS 600 and to components external to MTS 600. As an example, a database server 614 may receive a database transaction request from an application server 622 that is requesting data to be written to or read from data storage 612. The database transaction request may specify an SQL SELECT command to select one or more rows from one or more database tables. The contents of a row may be defined in a database record and thus database server 614 may locate and return one or more database records that correspond to the selected one or more table rows. In various cases, the database transaction request may instruct database server 614 to write one or more database records for the LSM tree—database servers 614 maintain the LSM tree implemented on database platform 610. In some embodiments, database servers 614 implement a relational database management system (RDMS) or object oriented database management system (OODBMS) that facilitates storage and retrieval of information against data storage 612. In various cases, database servers 614 may communicate with each other to facilitate the processing of transactions. For example, database server 614A may communicate with database server 614N to determine if database server 614N has written a database record into its in-memory buffer for a particular key.

Application platform 620, in various embodiments, is a combination of hardware elements and software routines that implement and execute CRM software applications as well as provide related data, code, forms, web pages and other information to and from user systems 650 and store related data, objects, web page content, and other tenant information via database platform 610. In order to facilitate these services, in various embodiments, application platform 620 communicates with database platform 610 to store, access, and manipulate data. In some instances, application platform 620 may communicate with database platform 610 via different network connections. For example, one application server 622 may be coupled via a local area network and another application server 622 may be coupled via a direct network link. Transfer Control Protocol and Internet Protocol (TCP/IP) are exemplary protocols for communicating between application platform 620 and database platform 610, however, it will be apparent to those skilled in the art that other transport protocols may be used depending on the network interconnect used.

Application servers 622, in various embodiments, are hardware elements, software routines, or a combination thereof capable of providing services of application platform 620, including processing requests received from tenants of MTS 600. Application servers 622, in various embodiments, can spawn environments 624 that are usable for various purposes, such as providing functionality for developers to develop, execute, and manage applications. Data may be transferred into an environment 624 from another environment 624 and/or from database platform 610. In some cases, environments 624 cannot access data from other environments 624 unless such data is expressly shared. In some embodiments, multiple environments 624 can be associated with a single tenant.

Application platform 620 may provide user systems 650 access to multiple, different hosted (standard and/or custom) applications, including a CRM application and/or applications developed by tenants. In various embodiments, application platform 620 may manage creation of the applications, testing of the applications, storage of the applications into database objects at data storage 612, execution of the applications in an environment 624 (e.g., a virtual machine of a process space), or any combination thereof. In some embodiments, application platform 620 may add and remove application servers 622 from a server pool at any time for any reason, there may be no server affinity for a user and/or organization to a specific application server 622. In some embodiments, an interface system (not shown) implementing a load balancing function (e.g., an F5 Big-IP load balancer) is located between the application servers 622 and the user systems 650 and is configured to distribute requests to the application servers 622. In some embodiments, the load balancer uses a least connections algorithm to route user requests to the application servers 622. Other examples of load balancing algorithms, such as are round robin and observed response time, also can be used. For example, in certain embodiments, three consecutive requests from the same user could hit three different servers 622, and three requests from different users could hit the same server 622.

In some embodiments, MTS 600 provides security mechanisms, such as encryption, to keep each tenant's data separate unless the data is shared. If more than one server 614 or 622 is used, they may be located in close proximity to one another (e.g., in a server farm located in a single building or campus), or they may be distributed at locations remote from one another (e.g., one or more servers 614 located in city A and one or more servers 622 located in city B). Accordingly, MTS 600 may include one or more logically and/or physically connected servers distributed locally or across one or more geographic locations.

One or more users (e.g., via user systems 650) may interact with MTS 600 via network 640. User system 650 may correspond to, for example, a tenant of MTS 600, a provider (e.g., an administrator) of MTS 600, or a third party. Each user system 650 may be a desktop personal computer, workstation, laptop, PDA, cell phone, or any Wireless Access Protocol (WAP) enabled device or any other computing device capable of interfacing directly or indirectly to the Internet or other network connection. User system 650 may include dedicated hardware configured to interface with MTS 600 over network 640. User system 650 may execute a graphical user interface (GUI) corresponding to MTS 600, an HTTP client (e.g., a browsing program, such as Microsoft's Internet Explorer™ browser, Netscape's Navigator™ browser, Opera's browser, or a WAP-enabled browser in the case of a cell phone, PDA or other wireless device, or the like), or both, allowing a user (e.g., subscriber of a CRM system) of user system 650 to access, process, and view information and pages available to it from MTS 600 over network 640. Each user system 650 may include one or more user interface devices, such as a keyboard, a mouse, touch screen, pen or the like, for interacting with a graphical user interface (GUI) provided by the browser on a display monitor screen, LCD display, etc. in conjunction with pages, forms and other information provided by MTS 600 or other systems or servers. As discussed above, disclosed embodiments are suitable for use with the Internet, which refers to a specific global internetwork of networks. It should be understood, however, that other networks may be used instead of the Internet, such as an intranet, an extranet, a virtual private network (VPN), a non-TCP/IP based network, any LAN or WAN or the like.

Because the users of user systems 650 may be users in differing capacities, the capacity of a particular user system 650 might be determined one or more permission levels associated with the current user. For example, when a user is using a particular user system 650 to interact with MTS 600, that user system 650 may have capacities (e.g., user privileges) allotted to that user. But when an administrator is using the same user system 650 to interact with MTS 600, the user system 650 may have capacities (e.g., administrative privileges) allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level. There may also be some data structures managed by MTS 600 that are allocated at the tenant level while other data structures are managed at the user level.

In some embodiments, a user system 650 and its components are configurable using applications, such as a browser, that include computer code executable on one or more processing elements. Similarly, in some embodiments, MTS 600 (and additional instances of MTSs, where more than one is present) and their components are operator configurable using application(s) that include computer code executable on processing elements. Thus, various operations described herein may be performed by executing program instructions stored on a non-transitory computer-readable medium and executed by processing elements. The program instructions may be stored on a non-volatile medium such as a hard disk, or may be stored in any other volatile or non-volatile memory medium or device as is well known, such as a ROM or RAM, or provided on any media capable of staring program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the disclosed embodiments can be implemented in any programming language that can be executed on a server or server system such as, for example, in C, C+, HTML, Java, JavaScript, or any other scripting language, such as VBScript.

Network 640 may be a LAN (local area network), WAN (wide area network), wireless network, point-to-point network, star network, token ring network, hub network, or any other appropriate configuration. The global internetwork of networks, often referred to as the “Internet” with a capital “I,” is one example of a TCP/IP (Transfer Control Protocol and Internet Protocol) network. It should be understood, however, that the disclosed embodiments may utilize any of various other types of networks.

User systems 650 may communicate with MTS 600 using TCP/IP and, at a higher network level, use other common Internet protocols to communicate, such as HTTP, FTP, AFS, WAP, etc. For example, where HTTP is used, user system 650 might include an HTTP client commonly referred to as a “browser” for sending and receiving HTTP messages from an HTTP server at MTS 600. Such a server might be implemented as the sole network interface between MTS 600 and network 640, but other techniques might be used as well or instead. In some implementations, the interface between MTS 600 and network 640 includes load sharing functionality, such as round-robin HTTP request distributors to balance loads and distribute incoming HTTP requests evenly over a plurality of servers.

In various embodiments, user systems 650 communicate with application servers 622 to request and update system-level and tenant-level data from MTS 600 that may require one or more queries to data storage 612. In some embodiments, MTS 600 automatically generates one or more SQL statements (the SQL query) designed to access the desired information. In some cases, user systems 650 may generate requests having a specific format corresponding to at least a portion of MTS 600. As an example, user systems 650 may request to move data objects into a particular environment 624 using an object notation that describes an object relationship mapping (e.g., a JavaScript object notation mapping) of the specified plurality of objects.

### Exemplary Computer System

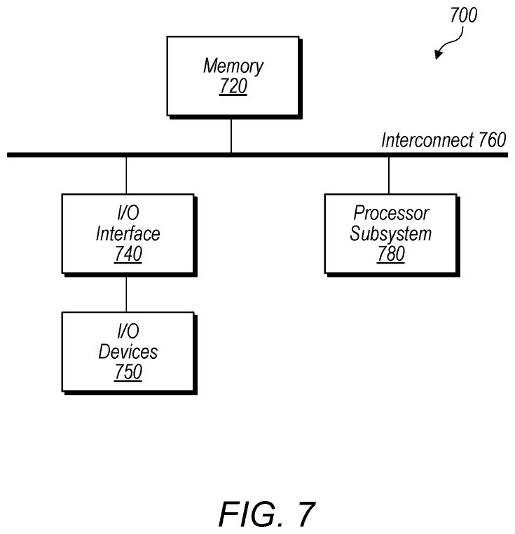

Turning now to FIG. 7, a block diagram of an exemplary computer system 700, which may implement system 100, platform 110, user device 160, MTS 600, and/or user system 650, is depicted. Computer system 700 includes a processor subsystem 780 that is coupled to a system memory 720 and I/O interfaces(s) 740 via an interconnect 760 (e.g., a system bus). I/O interface(s) 740 is coupled to one or more I/O devices 750. Although a single computer system 700 is shown in FIG. 7 for convenience, system 700 may also be implemented as two or more computer systems operating together.

Processor subsystem 780 may include one or more processors or processing units. In various embodiments of computer system 700, multiple instances of processor subsystem 780 may be coupled to interconnect 760. In various embodiments, processor subsystem 780 (or each processor unit within 780) may contain a cache or other form of on-board memory.

System memory 720 is usable store program instructions executable by processor subsystem 780 to cause system 700 perform various operations described herein. System memory 720 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 700 is not limited to primary storage such as memory 720. Rather, computer system 700 may also include other forms of storage such as cache memory in processor subsystem 780 and secondary storage on I/O Devices 750 (e.g., a hard drive, storage array, etc.). In some embodiments, these other forms of storage may also store program instructions executable by processor subsystem 780. In various embodiments, program instructions for implementing process flow engine 140 and GUI 200 may be included/stored within system memory 720.

I/O interfaces 740 may be any of various types of interfaces configured to couple to and communicate with other devices, according to various embodiments. In one embodiment, I/O interface 740 is a bridge chip (e.g., Southbridge) from a front-side to one or more back-side buses. I/O interfaces 740 may be coupled to one or more I/O devices 750 via one or more corresponding buses or other interfaces. Examples of I/O devices 750 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 700 is coupled to a network via a network interface device 750 (e.g., configured to communicate over WiFi, Bluetooth, Ethernet, etc.).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
accessing, by a first computer system, process flow information derived from a graphical user interface (GUI), wherein the process flow information specifies a process flow defining an ordering of a plurality of elements of the process flow, wherein the plurality of elements include a branch selector element that is connected to a plurality of branches that flow to a branch return element, and wherein a given branch of the plurality of branches includes a set of actions to be performed as part of traversing the given branch; and
executing, by the first computer system, the process flow, wherein the executing includes:
accessing state information that identifies which of the plurality of branches have been evaluated for traversal;
traversing ones of the plurality of elements of the process flow according to the ordering;
upon reaching the branch selector element:
determining, based on the state information, whether the plurality of branches includes a branch that has not been evaluated; and
in response to determining a particular one of the plurality of branches has not been evaluated, determining whether to traverse the particular branch based on a set of criteria; and
upon reaching the branch return element, determining whether to return to the branch selector element based on whether a particular number of the plurality of branches has been evaluated.

2. The method of claim 1, further comprising:
sending, by the first computer system, GUI information that is executable by a second computer system to display the GUI, wherein the GUI includes:
a set of elements selectable by a user to build the process flow; and
a graphical representation that depicts the process flow, including the plurality of elements and the plurality of branches; and
receiving, by the first computer system, the process flow information from the second computer system.

3. The method of claim 2, wherein the graphical representation does not depict a graphical loopback connection from the branch return element to the branch selector element.

4. The method of claim 1, wherein executing the process flow includes the first computer system evaluating the plurality of branches in an order specified by a user via the GUI.

5. The method of claim 1, further comprising:
in response to determining that the set of criteria associated with the particular branch are not satisfied, evaluating another branch of the plurality of branches without traversing the particular branch.

6. The method of claim 1, wherein the branch return and branch selector elements inherit a set of features from a parent branch element.

7. The method of claim 6, wherein the GUI is operable to:
present an element interface for the parent branch element that includes a set of options for defining the parent branch element as a branch return element or a branch selector element.

8. The method of claim 1, wherein the GUI is operable to:
present an element interface for the branch return element that includes an option for receiving an indication of the branch selector element.

9. The method of claim 1, wherein the plurality of branches includes a default branch that does not include any actions to be performed as part of traversing the default branch.

10. The method of claim 9, further comprising:
determining to not return to the branch selector element based on the default branch being traversed.

11. The method of claim 1, wherein the particular branch includes another branch selector element and another branch return element.

12. A non-transitory computer readable medium having program instructions stored thereon that are executable by a computer system to cause the computer system to perform operations comprising:
accessing process flow information that is obtained from a graphical user interface (GUI), wherein the process flow information specifies a process flow defining an ordering of a plurality of elements of the process flow, wherein the plurality of elements include a branch selector element that is connected to a plurality of branches that flow to a branch return element, and wherein a given branch of the plurality of branches includes a set of actions to be performed as part of traversing the given branch; and
executing the process flow, wherein the executing includes:
traversing ones of the plurality of element of the process flow according to the ordering;
upon reaching the branch selector element:
accessing state information that identifies which of the plurality of branches have been evaluated for traversal;
determining, based on the state information, whether the plurality of branches includes a branch that has not been evaluated; and
in response to determining a particular one of the plurality of branches has not been evaluated, determining whether to traverse the particular branch based on a set of criteria; and
upon reaching the branch return element, determining whether to return to the branch selector element based on whether a particular number of the plurality of branches has been evaluated.

13. The medium of claim 12, wherein the operations further comprise:
sending, to another computer system, GUI information that is executable to display the GUI, wherein the GUI includes:
a set of elements selectable by a user to build the process flow; and
a graphical representation that depicts the process flow, including the plurality of elements and the plurality of branches; and
receiving the process flow information from the other computer system.

14. The medium of claim 12, wherein the operations further comprise:
in response to determining that the set of criteria associated with the particular branch are not satisfied, determining, without traversing the particular branch, whether the plurality of branches includes another branch that has not been evaluated.

15. The medium of claim 12, wherein the operations further comprise:
evaluating the plurality of branches in an order specified by a user via the GUI.

16. The medium of claim 12, wherein the operations further comprise:
in response to evaluating the particular branch, updating, independent of whether the particular branch is traversed, the state information to indicate that the particular branch has been evaluated.

17. A system, comprising:
at least one processor; and
memory having program instructions stored thereon that are executable by the at least one processor to cause the system to perform operations comprising:
accessing process flow information that specifies a process flow defining an ordering of a plurality of elements, wherein the plurality of elements include a branch selector element that is connected to a plurality of branches that flow to a branch return element; and
executing the process flow, wherein the executing includes:
traversing ones of the plurality of element of the process flow according to the ordering;
upon reaching the branch selector element:
accessing state information that identifies which of the plurality of branches have been evaluated for traversal;
based on the state information, determining whether the plurality of branches includes a branch that has not been evaluated; and
in response to determining a particular one of the plurality of branches has not been evaluated, determining whether to traverse the particular branch based on a set of criteria; and
upon reaching the branch return element, determining whether to return to the branch selector element based on whether a particular number of the plurality of branches has been evaluated.

18. The system of claim 17, wherein the operations further comprise:
sending, to another computer system, GUI information that is executable to display an GUI that includes:
a set of elements selectable by a user to build the process flow; and
a graphical representation that depicts the process flow, including the plurality of elements and the plurality of branches; and
receiving the process flow information from the other computer system.

19. The system of claim 17, wherein the operations further comprise:
in response to determining that the set of criteria associated with the particular branch are not satisfied, determining, without traversing the particular branch, whether the plurality of branches includes another branch that has not been evaluated.

20. The system of claim 17, wherein the set of criteria for the particular branch includes a criterion that a user associated with the process flow be part of a particular group of users.
